(19) United States
(12) Patent Application Publication
(10) Pub. No.: US 2024/0185176 A1
(43) Pub. Date: Jun. 6, 2024

(54) SYSTEMS AND METHODS FOR INVENTORY MANAGEMENT

(71) Applicant: Walmart Apollo, LLC, Bentonville, AR (US)

(72) Inventors: Sung H. Kim, Bentonville, AR (US); Christopher R. Heeney, Bella Vista, AR (US); Nithya Jagatap, Bentonville, AR (US); Ryan S. Magnusson, Rogers, AR (US); Christian N. Beasley, Bentonville, AR (US); Brandon J. Easterling, Bella Vista, AR (US); Katherine M. Lafferty, Bentonville, AR (US)

(21) Appl. No.: 18/282,309

(22) PCT Filed: Mar. 14, 2022
(86) PCT No.: PCT/US2022/020164

§ 371 Date: Sep. 15, 2023

Related U.S. Application Data
(60) Provisional application No. 63/161,260, filed on Mar. 15, 2021.

(51) Int. Cl. G06Q 10/087; G06Q 10/0631; G06V 20/60

(52) U.S. Cl. CPC G06Q 10/087; G06Q 10/063114; G06V 20/60; G06V 2201/07

(57) ABSTRACT

In some embodiments, apparatuses and methods are provided herein useful to inventory management. In some embodiments, an inventory management system comprises inventory items having attached fiducial markers, a control circuit, and an application executed on a mobile device operable by a user. The mobile application is configured to present a real-world view of inventory items within a camera's field of view, capture information associated, with the fiducial markers, and transmit this information to the control circuit. The control circuit is configured to apply one or more information filters to identify inventory items having specified, attributes and transmit these identifications to the mobile application. The mobile application is configured to present an augmented view of the inventory items by displaying indications over the inventory items having the specified attributes to identify to the user which items require attention.

### TECHNICAL FIELD

This invention relates generally to retail facilities and, more particularly, to inventory management in retail facilities using augmented reality techniques.

### BACKGROUND

Maintaining sufficient stock of items in a retail facility is important for providing a satisfying customer experience. For example, if a customer is unable to find a desired item because the item is out of stock, the customer may become frustrated. Out of stock inventory can also lead to reduced sales. Many retail facilities task employees with ensuring that items are properly stocked. In some conventional approaches, an employee may enter a stock room or storage area with a list of items that need to be stocked (i.e., moved from the stockroom to the salesfloor). While this can be an effective way to stock a store, the process is prone to error and is time consuming. For example, an employee may forget to stock an item on the list, misread the list and stock the wrong item, etc. Additionally, unless an employee has the list of items, the employee will not know what items need to be stocked. These methods also do not quickly and efficiently alert the store associate to inventory items needing attention (e.g., recalled or expired items, priority items, items on clearance, etc.)

Accordingly, a need exists for improved systems and methods for managing inventory in a retail facility.

### BRIEF DESCRIPTION OF THE DRAWINGS

Disclosed herein are embodiments of systems, apparatuses and methods pertaining to inventory management using augmented reality. This description includes drawings, wherein:

FIG. 1 depicts a shelving unit accommodating inventory items having fiducial markers associated therewith, according to some embodiments;

FIG. 2A depicts a mobile device presenting a real-world view of a shelving unit accommodating inventory items having fiducial markers associated therewith, according to some embodiments;

FIG. 2B depicts a mobile device presenting an augmented view of a shelving unit accommodating inventory items having fiducial markers associated therewith, according to some embodiments;

FIG. 2C depicts a mobile device presenting an augmented view of a shelving unit accommodating inventory items having fiducial markers associated therewith, according to some embodiments;

FIG. 3 is a block diagram of a system for managing inventory using augmented reality, according to some embodiments; and

FIG. 4 is a flow diagram of a method for managing inventory using augmented reality, according to some embodiments; and

FIG. 5 is a block diagram of an exemplary system for use in implementing methods, techniques, devices, apparatuses, systems, servers, and sources for managing inventory using augmented reality, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to managing inventory using augmented reality, which allow a store associate to quickly and efficiently scan a large portion of an inventory storage area and be alerted to certain actions, such as picks (i.e., items that need to be replenished on the sales floor) or other items needing attention (e.g., recalled or expired items, priority items, items on clearance, products in an online order, etc.) using their mobile device. In this way, a store associate can quickly perform a visual inventory audit each time the associate scans the storage area with their mobile device.

In some embodiments, a system for inventory management comprises a retail facility having a storage area containing inventory items stored therein. Each inventory item has one or more fiducial markers associated therewith to uniquely identify each inventory item. In some approaches, the inventory item may be a product case containing a plurality of products, wherein each product case has one or more fiducial markers attached thereto. In other approaches, the inventory items may be individual products for sale, also known as “eaches,” wherein the eaches have one or more fiducial markers attached thereto. In other approaches, the inventory item may be a pallet having a plurality of products and/or product cases thereon, wherein each product and/or product case may have one or more fiducial markers attached thereto. In some approaches, the shelving units may also have one or more fiducial markers affixed thereto, which may be used to tie the inventory items to specific locations on the shelving unit.

The system further includes a control circuit configured to receive images and/or information relating to the fiducial markers associated with the inventory items located in a section of the storage area, captured using an image capture device. The section of the storage area generally corresponds to a field of view of the image capture device. In some approaches, the image capture device may form part of a mobile device (e.g., a mobile phone). In other approaches, the image capture device may be, for example, a fixed camera mounted in the storage area. In yet other approaches, the image capture device may be associated with, for example, a robot, drone, or other autonomous vehicle. The control circuit is further configured to use the information relating to the fiducial markers to identify and determine locations of inventory items in the section of the storage area. The control circuit executes an information filter to identify inventory items in the section of the storage area having a specified attribute and transmits to an application executing on the mobile device identifications of the inventory items in the section of the storage area having the specified attribute. Non-limiting examples of exemplary information filters include, but are not limited to, information filters relating to inventory picks, order picks, uncounted items, recalled items, featured items, clearance items, final markdown items, priority items, deleted items, purged items, expiration dates, harvest dates, and/or freshness dates. Other types or embodiments of information filters are also contemplated. In some approaches, the control circuit is configured to automatically select and apply the information filter from a plurality of information filters. In other approaches, the application executing on the mobile device receives from the user, and transmits to the control circuit, a selection of the information filter from a plurality of selectable information filters.

In some approaches, the application, when executed by the mobile device, is configured to present, on a user interface of the mobile device, a real-world view of the section of the storage area containing the inventory items. The application is also configured to display an augmented view of the of the section of the storage area by displaying an indication over each inventory item having the specified attribute. In some approaches, the application receives from the user, and transmits to the control circuit, one or more signals that the inventory items having the specified attribute have been picked, removed, or otherwise attended to by the user. In some approaches, the control circuit is further configured to determine an action item for one or more of the inventory items, and the application executing on the mobile device is configured to present an augmented view of the section of the storage area by displaying an indication over each inventory item having the specified attribute. Additionally, the application executing on the mobile device may receive from the user an action indication that the action item for the inventory item has been completed and the application may transmit the action indication or an associated signal to the control circuit.

In some approaches, the system further comprising an inventory management module. The control circuit may be configured to update the inventory management module upon receiving, from the application executing on the mobile device, the one or more signals that the inventory items having the specified attribute have been picked, removed, or otherwise attended to by the user. In some approaches, the control circuit may be further configured to determine that an inventory item is no longer present in the section of the storage area after a specified duration of time and update the inventory management module.

As previously discussed, a properly stocked salesfloor is important to a retail facility. For example, a properly stocked salesfloor can result in an improved customer experience and increased sales for the retail facility. Currently, retail facilities may rely on employees taking note of what items need to be stocked or picked before going to the stockroom to retrieve the items. However, these methods can be time consuming and inaccurate. These methods also do not quickly and efficiently alert the store associate to inventory items needing attention (e.g., recalled or expired items, priority items, items on clearance, etc.).

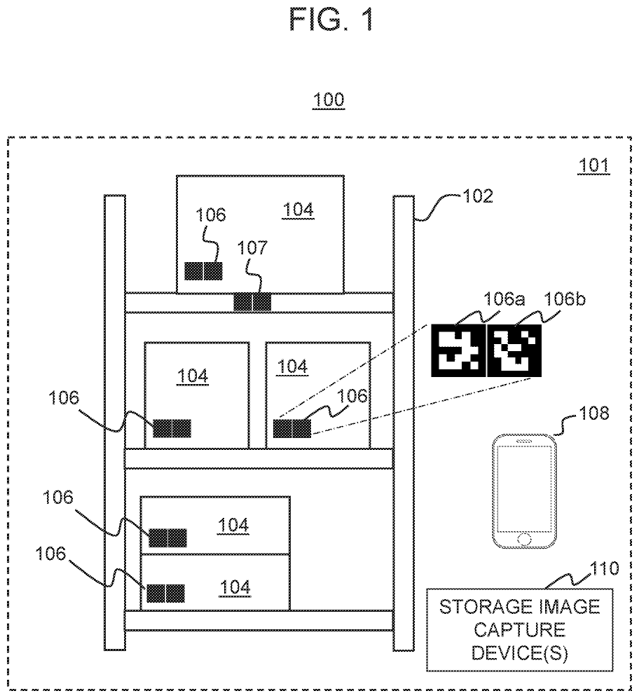

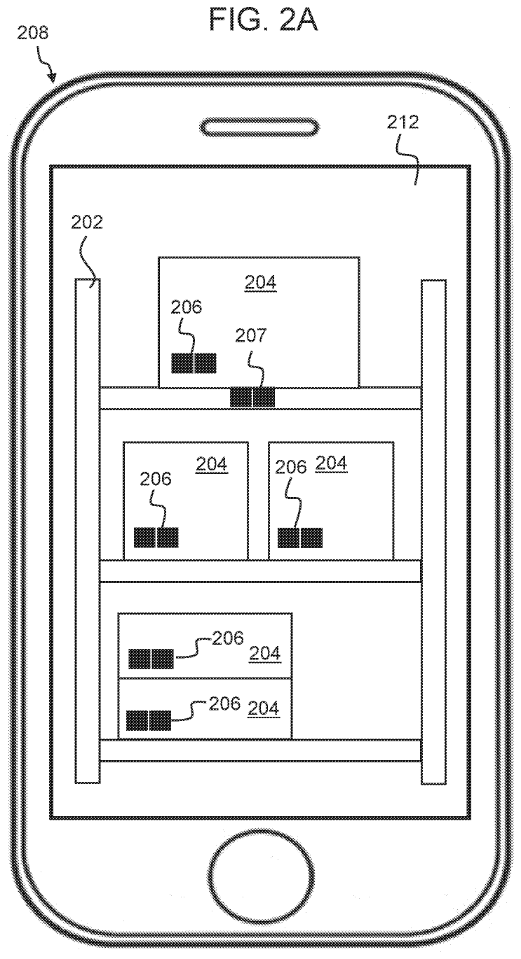

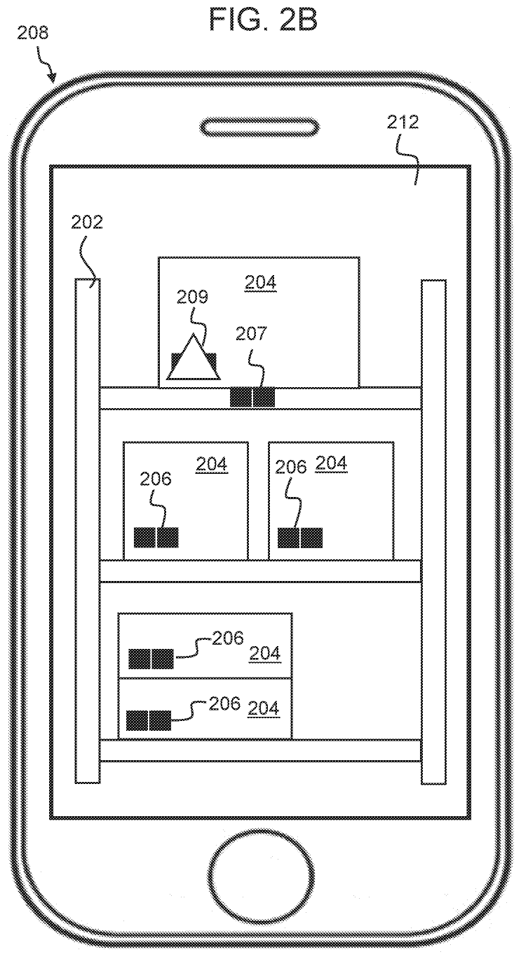

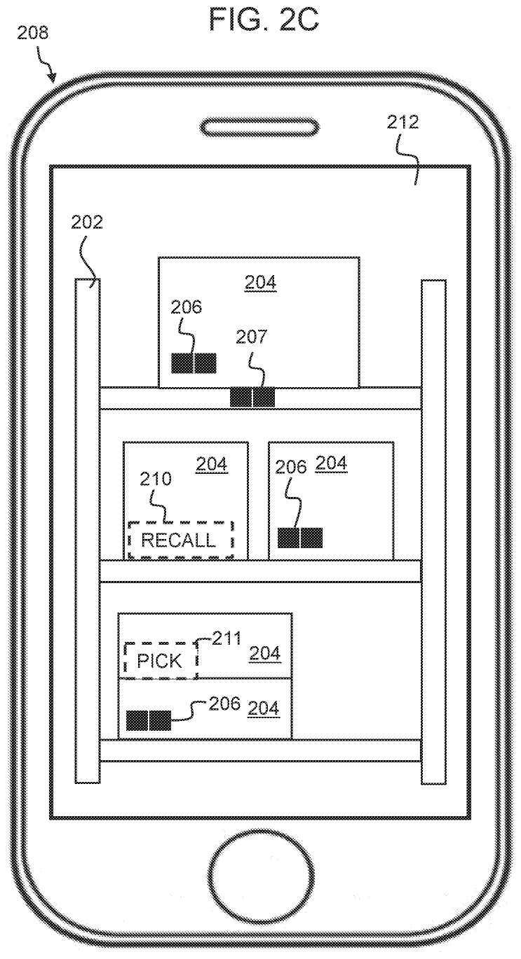

Described herein are systems, methods, and apparatuses for inventory management using augmented reality. In one embodiment, a storage area of a retail facility contains shelving units that accommodate stored inventory items. Each inventory item has one or more fiducial markers associated therewith. An image capture device captures images and/or information associated with fiducial markers attached to the inventory items, and the backend system identifies inventory items in the storage area in need of attention. When a user (e.g., a store associate) orients a suitable mobile device toward the shelving unit, an application executing on the mobile device (i.e., a mobile application) presents an augmented reality of the shelving unit, which includes indications and/or action items over inventory items requiring attention. The discussion of FIGS. 1 to 2C provides an overview of such a system.

FIG. 1 depicts an exemplary system 100 that includes a shelving unit 102 accommodating various inventory items 104 stored thereon. In some embodiments, the shelving unit may be generically referred to as a product storage unit, such that the product storage unit may be in the form of a shelf assembly such as illustrated or may be in any other product storage or support unit form such as a bin, table, rack, crate, pallet, modular, conveyor, by way of example. The shelving unit 102 may be located in any suitable area of a retail facility 101. For example, in some approaches, the shelving unit 102 may be located in a non-public storage area (i.e., in a backroom) of the retail facility. In other approaches, the shelving unit 102 may be located in a public area (i.e., on the sales floor) of the retail facility. While FIG. 1 depicts only one shelving unit, it should be understood that the storage area may include multiple shelving units storing similar or different inventory items 104 for sale. It should also be understood that when the inventory items are pallets, shelving units may not be used or needed. The retail facility 101 may be any physical facility at least partially operated, used, or controlled by a retail entity and may include public-accessible and/or non-public accessible spaces, such as a retail store, a storage facility, a distribution facility, a fulfillment facility, for example.

Each inventory item 104 has a tag 106 attached thereto formed by a one or more fiducial markers (106a and 106b). Although FIG. 1 depicts each inventory item having two fiducial markers associated therewith, one or more fiducial markers may be used for each inventory item 104. The fiducial markers are generally attached to the outer packaging of the inventory items 104 and the inventory items 104 are generally positioned on the shelving unit 102 in a manner such that the fiducial markers forming the tag 106 are visible from the front of the shelving unit. Shelf tags 107 comprising one or more fiducial markers may also be affixed to locations on the shelving unit itself.

The terms “fiducial” and “fiducial marker” denote a visible object used as a point of reference in an imaging system. Suitable fiducial markers for use in the systems and methods describe herein include any fiducial marker that is visible or otherwise detectable by a camera of a mobile device from a distance. In some approaches, suitable fiducial markers are low resolution fiducials. The use of low-resolution fiducial markers is preferred because they can be deciphered in less time and from greater distances than higher resolution markers, such a QR codes. This allows a store associate to quickly and efficiently read large areas at once, as opposed to scanning box-by-box, which is tedious and time consuming.

One non-limiting example of a low-resolution fiducial marker suitable for use in the systems and methods described herein is an ArUco marker (see 106a and 106b in FIG. 1). An ArUco marker is a square marker comprising a wide black border and an inner binary matrix within the border that determines the marker's identifier. In some approaches, each inventory item tag (and/or shelf tag) comprises a pair of fiducial markers having unique identifiers, which together encode a unique integer associated with each tag. The use of two fiducial markers allows for a greater number of unique integers to be generated, which is especially useful in applications where a large number of unique tags are needed, such as in inventory management systems. Thus, in some approaches, each inventory item tag may even be associated with three, four, or more fiducial markers, depending on the number of unique integers desired.

The fiducial markers may be any suitable size that is visible or otherwise detectable by an imaging device (e.g., a camera) of a mobile device from a distance. In some approaches, the viewable distance may range from about 4 feet to about 6 feet, in some approaches from about 3 to about 5 feet, depending on the attributes of the imaging device used to view the markers. In some approaches the viewable distance may even be greater than 6 feet, depending on the size of the fiducial markers and the camera used to image them.

In some approaches, the inventory items 104 may be product cases containing a plurality of products, wherein each product case has a tag comprising one or more fiducial markers attached thereto. In other approaches, the inventory items may be individual products for sale, also known as “eaches,” wherein the eaches are individually tagged with one or more fiducial markers. In some approaches the product cases may contain same or different products. In some approaches, the inventory items 104 may be pallets of products or product cases, which may contain the same or different products and/or product cases. In some approaches, the inventory items 104 may be inner packs contained within a product case. The term “inner pack” generally refers to one or more groups of packaged products within a product case (e.g., a case of 12 bottles may contain four inner packs of three bottles each). In some approaches, each inner pack within a product case may be tagged with one or more fiducial markers. In such a scenario, the outer product case may also be tagged with fiducial markers in some approaches. It should be understood that fiducial markers may be placed on or otherwise be affixed to pallets, product cases, inner packs, and/or eaches in any combination suitable for efficient inventory management.

Various locations on the shelving unit 102 may also have one or more shelf tags 107 attached thereto, each tag 107 comprising one or more fiducial markers. The fiducial markers forming the tags 107 may have similar properties to the fiducial markers described above with reference to inventory item tags. The shelf tags 107 enable the tying of inventory items 104 to locations on the shelving unit 102.

The system 100 further includes a mobile device 108 (e.g., cellular telephone, tablet, portable computer, laptop computer, personal digital assistant, wearable device, eyeglasses, goggles, media player, etc.) operable by a user, for example a store associate. The mobile device 108 may include an image capture device (e.g., a camera) and is configured to capture images of, and/or to decipher, the fiducial markers forming the inventory tags. In some approaches, the system may include one or more storage image capture devices 110 disposed about the storage area. In some approaches, the one or more storage image capture devices 110 may be fixed or otherwise mounted in the storage area, for example, on or near shelving unit 102 or on a ceiling or other structure, such that each image capture device 110 has a field of view that includes at least a portion of a shelving unit 102. In one example, a storage image capture device 110 may be a fixed camera mounted on a shelving unit 102 and may have a field of view that includes all or part of an opposite shelving unit. In other approaches, the storage image capture device 110 may be associated with, or form part of, for example, a robot, drone, or other autonomous vehicle. The storage image capture device 110 may capture and transmit images and/or information relating to fiducial markers in the storage area to the mobile device 108 and/or to the backend system.

When the store associate enters the storage area, the associate opens or otherwise launches a mobile application executing on their mobile device 108 and orients the camera of the mobile device toward the shelving unit 102. In some approaches, when the store associate opens the application executing on their mobile device 108, the associate may be presented with a number of modules for selection (e.g., an inventory module, an order fulfillment module, an audit module, etc.) and may select the appropriate module based on the desired task by tapping on the appropriate icon displayed by a display device of the mobile device. The mobile application may then present a real-world view of the shelving unit 102 within the field of view of the camera.

FIG. 2A depicts a mobile device 208 having a display device 212 presenting a real-world view of a shelving unit 202 accommodating inventory items 204, each inventory item 204 having a tag 206 comprising pair of fiducial markers associated therewith. Also visible is a shelf tag 207 comprising a pair of fiducial markers located on a shelf of the shelving unit 202.

In some approaches, the backend system is configured to identify the mobile device 208 when the associate launches the mobile application. The application captures the fiducial markers present in the camera's field of view (using, for example, an image capture device associated with the mobile device 208) and transmits to the backend system the images and/or the information associated with the captured fiducial markers. Alternatively, or in addition, image capture devices disposed about the storage area may capture and transmit images and/or information associated with the fiducial markers to the backend system and/or to the mobile device 208.

The backend system uses the images and/or information relating to the fiducial markers to identify the inventory items 204 on the shelving unit 202. In some approaches, the backend system is configured to decode the fiducial markers in the images received to decipher their unique identifiers. The backend system may also include an image processing module, which may be configured to process the received images.

In some approaches, the backend system may identify the inventory items 204 by, for example, querying databases containing data relating to the inventory items 204 and fiducial markers. The system may also determine locations of the inventory items on the shelving unit 202 by, for example, using one or more of the shelf tags 207. The system then applies one or more information filters to identify inventory items 104 having specified attributes. For example, it may be important to identify inventory items in need of restocking. In another example, it may be important to identify items that are recalled, so that they can be removed from inventory stock. In another example, it may be important to identify and accurately count items during and inventory audit. In another example, it may be important to identify inventory items that form part of an online pick-up and delivery order.

Non-limiting examples of information filters applied by the system may relate to, for instance, inventory picks, order picks, uncounted items, recalled items, featured items, clearance items, final markdown items, priority items, deleted items, purged items, expiration dates, harvest dates, and/or freshness dates. Other types or embodiments of information filters are also contemplated. For instance, an example of an information filter may include items that have not yet been counted during an inventory audit. Another example of an information filter may be products a customer has purchased online, and which need to be picked by a store associate to fulfill the customer's online order. Yet another example of an information filter may be items that are prioritized for restocking based on one or more factors such, for example, as work efficiency, historical sales, projected sales, weather forecasts, scheduled holidays, etc.). In some approaches, information filters may be applied one at a time. In other approaches, multiple information filters may be applied simultaneously.

In some approaches, the store associate may select one or more information filters to be applied by the backed system by making selections using the mobile device. In other approaches, the backend system may select one or more information filters to apply. In both scenarios, the backend system applies the one or more information filters and identifies inventory items having the specified attribute(s). The system transmits to the application on the mobile device the identifications of the inventory items 204 having the specified attribute(s) and the application presents an augmented view of the shelving unit wherein one or more indications are displayed over each inventory item and/or associated tag having the specified attribute(s).

Indications displayed in the augmented view may comprise any symbol, shape, icon, or text, and may have any suitable color. Suitable indicators may be based on the type of information filter(s) used, ease of viewing, user preference, etc. In one example, the information filter may comprise colored shapes, and possible indicators may include a red square to indicate no pick or other action is needed, a green triangle to indicate the items needs to be picked, and a yellow triangle to indicate confirmation of the pick is pending. In another example, the system may display a single indication to denote the item needs to be picked. For example, FIG. 2B depicts a mobile device 208 having a display device 212 presenting an augmented view of a shelving unit 202, wherein a triangle icon 209 is displayed over an inventory item (and its attached fiducial markers) indicate the item needs to be picked.

In another example, illustrated in FIG. 2C, the system may display text indications associated with various information filters. For example, in FIG. 2C the information filters applied relate to recalled items and items that need to be picked. The system presents an augmented view of the shelving unit 202, wherein a “RECALL” indicator 210 is displayed over one inventory item and a “PICK” indicator 211 is displayed over another inventory item.

The store associate proceeds to remove from the shelving unit 202 the inventory item(s) 204 having the specified attributes and signals using the mobile application that the inventory items 204 have been attended to (e.g., removed from the shelving unit 202). In some approaches, the store associate may tap the display device 212 on the indication displayed over the inventory items having the selected attribute(s) to denote that the items have been removed or otherwise attended to, at which point the indications may change in form, shape and/or color, or may disappear altogether.

In some approaches, the system may display or otherwise indicate to the store associate via the display device 212 on the mobile device 208 that only some of the products within a particular product case or pallet need to be picked or otherwise removed. For example, the mobile device 208 may display an indication or direction to the store associate via the display device 212 to remove a certain number of products or inner pack(s) from the product case or pallet. Upon removal, the store associate may tap the display device 212 on the indication displayed over the product case or pallet to denote that the required number of products or inner pack(s) have been removed and the inventory management module may update the quantity of the products or inner packs remaining in the product case or pallet associated with the related fiducial markers. In some scenarios, a product case or pallet may contain multiple different products (or UPCs) having different quantities therein. The system may display or otherwise indicate to the store associate via the display device 212 that a certain product within the product case or pallet needs to be picked or otherwise removed in a certain quantity. Upon removal, the store associate may tap the display device 212 on the indication displayed over the product case or pallet to denote that the particular product has been removed and the inventory management module may update the quantity of the products remaining in the product case or pallet associated with the related fiducial markers.

In some approaches, the system may display or otherwise indicate to the store associate via the display device 212 on the mobile device 208 to select only certain products having an expiration date within a certain range or priority. If the store associate selects a product having an expiration date outside of the certain range or priority, the mobile device 208 may provide an alert to the store associate (e.g., visual, audible, tactile, etc.) that the wrong product was selected and may highlight the correct product to select.

In one non-limiting example, a store associate may enter the storage area to pick a perishable item. The store associate launches the mobile application and scans the storage area. The display device 212 then displays an indication over the shelf tag where the perishable item is located and/or over the fiducial marker(s) associated with the product case(s) of the perishable item to let the store associate know which product case to pick from. In some cases, there may be multiple product cases of the same product from which the store associate can choose. In some approaches, the display device 212 may display an indication over only the product cases containing product having an expiration date within a specified range or priority.

In some approaches, it may not be clear to the store associate which product cases have an expiration date within the specified range or priority and the store associate may select a product having an expiration date outside the specified range or priority and may proceed to tap on the icon to indicate the selection. In such a scenario, the display device 212 may provide an alert to the store associate that the wrong product has been selected and may display an indication over only those products or cases having an expiration date within the specified range or priority. Upon removal, the store associate may tap the display device 212 on the indication displayed over the product case to denote that the correct product has been removed.

The backend system may then communicate with an inventory management module (or system) to indicate that inventory items have been removed from their respective locations on the shelving unit (or otherwise attended to) and the inventory management module updates the location and/or status of the inventory items. In scenarios where only a partial case or pallet is picked, the backend system may communicate with the inventory management module (or system) to update the number of products or inner packs remaining in the product case (or on the pallet) and the updated inventory status is then linked to the fiducial marker(s) associated with that product case or pallet.

In some approaches, the backend system may also determine one or more action items for the inventory items 204 and may transmit these action items to the mobile application. The application then displays in the augmented view an action indicator over inventory items and/or associated tags in need of the action items. An action indicator may comprise, for example, a text label indicating a specific action is needed. The application then receives from the user a signal that the action item for the inventory item has been completed, and the application transmits the signal to the control circuit.

The backend system applies one or more information filters as described above and identifies inventory items 204 requiring attention based on the information filter(s) applied. In some approaches, the information filters may be applied automatically at set intervals, in real time, or on demand by a user. In some approaches, when the store associate enters the storage area and launches the mobile application (or alternatively, enters the storage area with the mobile application already running on the mobile device), the backend system may cause the application to provide an alert (e.g., a sound or visual alert) to alert the store associate that one or more inventory items 204 in that storage area require attention based on recent information filter(s) used. In some approaches, the store associate may orient their mobile device toward a shelving unit 202 in the storage area and the mobile application may display an augmented view of the storage area, in which icons or other indications are displayed over inventory items 204 needing attention or other actions, as described above, enabling the associate to quickly identify the items visually.

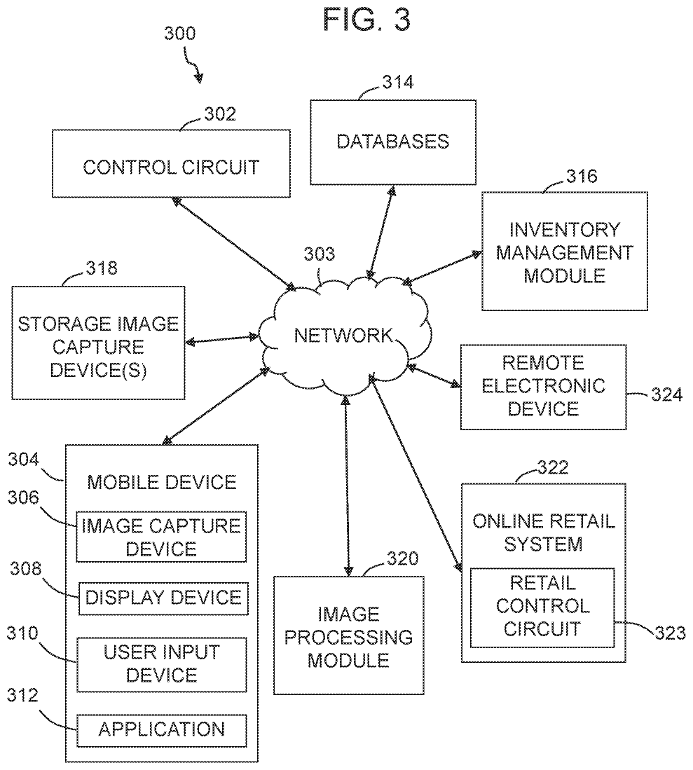

While the discussion of FIGS. 1 to 2C provides an overview of an exemplary system for inventory management, the discussion of FIG. 3 provides additional detail regarding such a system.

FIG. 3 is a block diagram of a system for inventory management 300, according to some embodiments. The system 300 includes a control circuit 302, a mobile device 304, databases 314, and an inventory management module 316. In some approaches, the system 300 may further include one or more storage image capture devices 318 disposed about the storage area. The one or more storage image capture devices 318 may be, for example, fixed cameras and/or they may be associated with, or form part of, for example, a robot, drone, or other autonomous vehicle. The system 300 may further include and online retail system 322 comprising a retail control circuit 323 and, in some approaches, a remote electronic device 324. One or more of the control circuit 302, mobile device 304, databases 314, inventory management module 316, storage image capture device(s) 318, image processing module 320, online retail system 322, retail control circuit 323, and remote electronic device 324 are communicatively coupled via a network 303. Accordingly, the network 303 can be of any suitable type. For example, the network 303 can include a local area network (LAN) and/or wide area network (WAN), such as the Internet. The network can include wired and/or wireless links and all other relays, switches, transceivers, and/or networking components.

The databases 314 are configured to store data associated with inventory items and associated inventory tags. An inventory database contains data associated with the inventory items such as, for example, UPC data, product descriptions, stock levels, locations, status, open action items (e.g., recalls), expiration dates, freshness data, and the like. The control circuit 302 may query the inventory database when various information filters are applied to determine which inventory items require attention by a store associate and to determine locations of inventory items.

A tag database contains data related to the fiducial markers used to tag the inventory items. The tag database may contain information associating fiducial markers with tags and associating tags with inventory items. The tag database may also track which tags and/or fiducial markers are currently being used, their locations, and which tags/fiducial markers to use next for new inventory items. The control circuit 302 may also query the tag database when various information filters are applied to determine which inventory items require attention by a store associate and to determine locations of inventory items.

The inventory management module 316 can take any suitable form. For example, in some approaches, the inventory management module 316 may comprise, or form part of, an inventory management system that is communicably coupled to the control circuit 302. In another approach, the inventory management module 316 may be a module executable by the control circuit 302. In either scenario, one or more of the databases 314 may form part of, be associated with, or be separate from, the inventory management module 316 and/or the control circuit 302.

The mobile device 304 can be of any suitable type. For example, the mobile device 304 can be an electronic device such as a smartphone, tablet, etc. In some approaches, the mobile device may take the form of a portable computer, laptop computer, personal digital assistant, wearable device, eyeglasses, goggles, or media player. The mobile device 304 includes an image capture device 306 (e.g., a camera), a display device 308 (e.g., a light emitting diode (LED), liquid crystal display (LCD), etc. device), and a user input device 310 (e.g., a keyboard, trackpad, number pad, touchscreen, etc.). In some embodiments, the image capture device 306, display device 308, and user input device 310 are integrated into a single component, such as a touchscreen device. The mobile device 304 is configured to execute a mobile application 312, which may be associated with the retailer.

The storage image capture device 318 may be any suitable image capture device. For example, the storage image capture device 318 may include one or more optical sensors, image sensors, or other suitable sensors configured to capture images and/or fiducial marker information in the storage area. In some approaches, the storage area image capture device 318 may be a fixed camera that is mounted to a structure in the storage area. For example, a fixed camera may be mounted on a shelving unit and may have a field of view that includes at least a portion of an opposite shelving unit. In other approaches, a fixed camera may be mounted on a ceiling or other structure in the storage area and may have a field of view that includes all or part of one or more shelving units. In yet other approaches, the storage image capture device 318 may be associated with, or form part of, for example, a robot, drone, or other autonomous vehicle. The storage image capture device 318 is configured to communicate with, and transmit images and/or associated information to, the control circuit 302 and/or the mobile device 304.

The control circuit 302 generally transmits and receives information to and from the mobile application 312 and, in some approaches, the storage image capture device 318, and uses the received information to make determinations about the inventory items. The control circuit 302 also communicates with, or may include, one or more of the inventory management module 316 and the databases 314. The control circuit 302 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 302 is configured (for example, by using corresponding programming as will be well understood by those skilled in the art) to carry out one or more of the steps, actions, and/or functions described herein, including one or more executable modules. Additionally, in some embodiments, the control circuit 302 can be implemented at a server.

In some approaches, the control circuit 302 operably couples to a memory. The memory may be integral to the control circuit 302 or can be physically discrete (in whole or in part) from the control circuit 302 as desired. This memory can also be local with respect to the control circuit 302 (where, for example, both share a common circuit board, chassis, power supply, and/or housing) or can be partially or wholly remote with respect to the control circuit 302 (where, for example, the memory is physically located in another facility, metropolitan area, or even country as compared to the control circuit 302).

This memory can serve, for example, to non-transitorily store the computer instructions that, when executed by the control circuit 302, cause the control circuit 302 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

In one embodiment, the control circuit 302 receives, from the mobile application and/or the storage image capture device(s) 318, images and/or information relating to the fiducial markers associated with the inventory items and uses this information to identify the inventory items on the shelving unit, the sales floor, or wherever the inventory items are stored. The control circuit 302 may also receive images and/or information relating to fiducial markers associated with shelf tags. In some approaches, the control circuit 302 is configured to decode the fiducial markers in the images received to decipher their unique identifiers. The control circuit 302 may also include, or be associated with, an executable imaging processing module 320, which may be configured to process images received from the various image capture devices. For example, the image processing module 320 may be configured to convert received images from one format to another (e.g., grayscale, binary, infrared, etc.) depending on the intended use of the images.

The control circuit 302 may identify the inventory items (and, in some approaches, their locations) by, for example, querying the databases 314 containing data relating to the inventory items and fiducial markers. The control circuit 302 may also determine locations of the inventory items on the shelving unit by, for example, using one or more of the shelf tags.

The control circuit 302 is also configured to apply one or more information filters to identify inventory items having specified attributes such as, for example, inventory items that need to be picked, or have been recalled, expired, etc. In some approaches, the control circuit 302 may select the information filter(s) to apply. The information filer(s) may be selected based on, for example, a time schedule, machine learning, etc. In other approaches, the control circuit may receive a selection of an information filter from the mobile application, the selection made by a store associate operating the mobile device.

The control circuit 302 is configured to identify the inventory items in the storage area (e.g., in the real-world view displayed by the mobile application) having the specified attribute(s) associated with the information filter(s) applied. For example, the control circuit identifies which items need to be picked, have been recalled, are expired prioritized, etc. based on the information filter(s) applied. The control circuit 302 transmits these identifications to the application 312 executing on the mobile device 304. In some approaches, the control circuit 302 may also determine any action items that may be needed or outstanding for one or more of the inventory items and may similarly transmit these identifications to the application 312.

In some approaches, the control circuit 302 may cause the mobile application 312 to provide an alert (e.g., a sound or visual alert) to alert the store associate that one or more inventory items in the storage area require attention, for example, when the associate launches the mobile application in the storage area or already has the mobile application running on their mobile device upon entering the storage area. In this approach, the control circuit 302 may continuously or intermittently receive images and/or inventory fiducial marker information from storage image capture device(s) 318 in the storage area. The control circuit 302 uses this information to identify the inventory items and their locations and identifies one or more inventory items in need of attention by applying the information filters. In some approaches, the information filters may be applied automatically and/or intermittently at fixed intervals and/or in real time. The control circuit 302 then communicates the alert to the mobile application 312 on the store associate's mobile device 304 upon receiving a signal from the mobile application 312 that the mobile device 304 is in the storage area.

Upon receiving a signal from the application 312 that the relevant inventory items have been removed by the associate, attended, to, and/or actions items have been resolved, the control circuit 302 may communicate with the inventory management module 316 and/or one or more of the databases 314 to update the status and/or location of the relevant inventory items.

The control circuit 302 may also be configured to cooperate with the inventory management module 316 and/or one or more of the databases 314 to determine that an inventory item is missing from the storage area. For example, when a store associate scans part of the storage area with their mobile device 304, the image capture device 306 captures the fiducial marker(s) associated with an inventory item (and, in some approaches, the shelf location) in the image capture device's field of view. The application 312 transmits the information associated with the fiducial markers to the control circuit 302 and the control circuit identifies the inventory item associated with the fiducial markers and determines the location of the item on the shelving unit. In some instances, an inventory item may have been previously removed from its location on the shelving unit without an associate indicating its removal using the application 312. In such a scenario, the control circuit 302 may expect to receive fiducial marker information associated with that inventory item based on, for example, routine querying of databases, inventory module updates, previous scans, etc. When the control circuit does not receive this expected information, the control circuit 302 may determine in real time or after a certain duration of time as passed from when the control circuit 302 last identified and/or located the item (e.g., 36 hours), that the inventory item is missing. The control circuit 302 may then communicate with the inventory management module 316 and/or one or more of the databases 314 to purge the inventory item or otherwise update the system, module, and/or databases.

In some approaches, the system (or components thereof) may function in an “audit mode,” wherein the control circuit 302 is configured to cooperate with the inventory management module 316 and/or one or more of the databases 314 to count inventory items in the storage area based on the fiducial markers on each product and to determine whether inventory items have already been counted. For example, during an annual inventory audit, a store associate may select an audit mode or module on the mobile device 304 and may scan part of the storage area with their mobile device 304. The image capture device 306 captures the fiducial marker(s) associated with inventory items (and, in some approaches, shelf locations) in the image capture device's field of view. The application 312 transmits the information associated with the fiducial markers to the control circuit 302 and the control circuit 302 identifies the inventory items associated with the fiducial markers, counts the inventory items, and stores indications that each inventory item identified has been counted, which may be used by the control circuit 302 to form a running tally of inventory for a particular product or groups of products. In subsequent scans (e.g., by the same or different store associate using the same or different mobile device 304), if the control circuit 302 identifies one more inventory items that have not yet been counted, the control circuit 302 identifies the one or more uncounted inventory items, counts the inventory items, stores indications that each inventory item identified has been counted, and updates the running tally. In some approaches, when the control circuit 302 identifies an inventory item that has not yet been counted, the control circuit 302 may cause the mobile device to provide an audible alert (e.g., a “pop” sound) to alert the store associate to the newly counted inventory items. In this way, store associates may quickly and efficiently perform inventory audits and counts may be easily repeated to increase inventory count accuracy.

In some approaches, the system 100 may further include and/or interface with the online retail system 322. The online retail system 322 enables customers to shop for items remotely (e.g., via a computer, smart phone, or the like) and place an order for delivery or for collection at the retail facility or at another suitable location (e.g., “online pickup and delivery”). The online retail system 322 comprises a retail control circuit 323 configured to communicate with the control circuit 302 and to communicate (directly or indirectly, e.g., via the control circuit 302) with a remote electronic device 324 (e.g., a customer's remote electronic device).

The remote electronic device 324 may be any suitable electronic device capable of communicating via a network (e.g., network 303) to remotely execute a purchase transaction with the retailer associated with the retail facility. For example, the remote electronic device 324 may comprise a personal computer, portable computer, laptop, personal digital assistant, smartphone, tablet, or the like. The remote electronic device 324 may includes a display device (e.g., a light emitting diode (LED), liquid crystal display (LCD), etc.) and a user input device (e.g., a keyboard, trackpad, number pad, etc.). In some embodiments, the display device and user input device are integrated into a single component, such as a touchscreen.

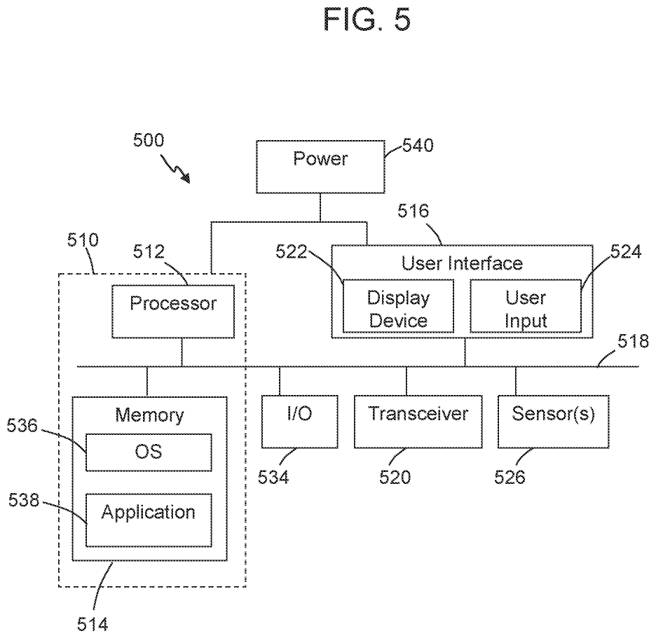

The remote electronic device 324 may be configured to execute an application, which may be affiliated or associated with the retail facility and/or the retailer operating the facility. The application comprises computer program code that is configured to be installed on and executed by the remote electronic device 324 (e.g., by a processor or control circuit of the remote electronic device 324, described in more detail with respect to FIG. 5). The application can be executed by the remote electronic device 324 in concert with other software modules or applications (computer program code), or groups of applications, such as operating systems, locationing applications (e.g., a mapping, GPS, etc. applications), two-factor authentication (TFA) applications, single sign on (SSO) applications, graphics processing applications, security applications, etc.

The application may be an online shopping application, which allows a customer to view and select products for purchase and to remotely execute a purchase transaction for those products. In such embodiments, the application can be a dedicated application (e.g., an application specific to a retailer or to inventory management) or a general application that while not a “dedicated application” can perform the functions as described herein with respect to remotely viewing products for purchase and initiating and executing purchase transactions. In some embodiments, the application is an add-on application installed on the remote electronic device 324 and that cooperates with other application(s) or programs of the remote electronic device 324, such as the operating system and works with the other application(s) or programs to provide the functionality described herein. In some embodiments, the add-on application is an add-on browser application that cooperates with graphical displays generated by and transmitted to the remote electronic device 324 from the control circuit 302, the retail control circuit 323, or other servers for display at the remote electronic device 324. In some embodiments, the application is integral with other applications of the mobile device such as the operating system. Where the application is integral with the operating system, the application may be considered a functional portion or module of the operating system, such as a browser or other dedicated functional module.

The retail control circuit 323 may be communicably coupled to the control circuit 302, the store associate's mobile device 304, the databases 314, the inventory management module 316, the storage image capture device(s) 318, the image processing module 320, and/or the remote electronic device 324 by network 303. The retail control circuit 323 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The retail control circuit 323 is configured (for example, by using corresponding programming as will be well understood by those skilled in the art) to carry out one or more of the steps, actions, modules, and/or functions described herein. Additionally, in some embodiments, the retail control circuit 323 can be implemented at a server.

By one optional approach, the retail control circuit 323 operably couples to a memory. The memory may be integral to the retail control circuit 323 and/or can be physically discrete (in whole or in part) from the retail control circuit 323 as desired. This memory can also be local with respect to the retail control circuit 323 (where, for example, both share a common circuit board, chassis, power supply, and/or housing) or can be partially or wholly remote with respect to the retail control circuit 323 (where, for example, the memory is physically located in another facility, metropolitan area, or even country as compared to the retail control circuit 323).

This memory can serve, for example, to non-transitorily store the computer instructions that, when executed by the retail control circuit 323, cause the retail control circuit 323 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The retail control circuit 323 may be configured to receive product selections from the remote electronic device 324 and communicate the product selections to the control circuit 302 and/or the store associate's mobile device 304 for order fulfilment. A mobile application 312 executing on the store associate's mobile device 304 may then display on the display device 308 of the mobile device 304 an augmented view of the storage area or sales floor identifying products needing to be picked to fulfill the customer's order. The indicator may also identify the quantity of items needing to be picked to fulfill the order. In some approaches, the store associate may fulfill multiple orders concurrently and the system may display different indicators for different orders to denote to the store associate which products are associated with which order. In this way, the system may be used by store associates to quickly and efficiently fulfill online customer orders.

In one non-limiting example, when a store associate opens the application on their mobile device, the associate may select a module associated with order fulfillment by tapping on an icon on the display device and the display device may present a list of pending orders needing to be fulfilled. The store associate may select one or more orders to fulfill by tapping on the display device and may proceed to scan areas of the storage area or sales floor where the products to be picked are located. The display device may then present an augmented view of areas of the storage area or sales floor having the products needing to be picked by displaying an indication (and, in some approaches, a quantity) of the products to be picked. The store associate picks each product in the online order and taps the display device on the indication displayed over each product to denote that the products have been picked, at which point the indications may change in form, shape and/or color, or may disappear altogether. The control circuit may then communicate with the online retail system to notify the remote electronic device that the order has been fulfilled.

The store associate's mobile device 304 is generally configured to capture and transmit information associated with fiducial markers affixed to inventory items and shelving units and to present an augmented view of a storage area containing these items to quickly and efficiently identify to a store associate inventory items that need attention (i.e., need to be picked, removed, are recalled, expired, prioritized items, etc.). In some embodiments, the mobile device 304 includes application 312, which, in some approaches, may be associated with the retailer.

In some embodiments, the application 312 comprises computer program code that is configured to be installed on and executed by the mobile device 304 (e.g., by a processor or control circuit of the mobile device 304, described in more detail with respect to FIG. 5). The application 312 can be executed by the mobile device 304 in concert with other software modules or applications (computer program code), or groups of applications, such as operating systems, locationing applications (e.g., a mapping, GPS, etc. applications), two-factor authentication (TFA) applications, single sign on (SSO) applications, graphics processing applications, security applications, etc. In some embodiments, the application 312 is an augmented reality application, as described herein. In such embodiments, the application can be a dedicated application (e.g., an application specific to a retailer or to inventory management) or a general application that while not a “dedicated application” can perform the functions as described herein with respect to the augmented reality application. In some embodiments, the application 312 is an add-on application installed on the mobile device 304 and that cooperates with other application(s) of the mobile device 304, such as the operating system and works with the other application/s to provide the functionality described herein. For example, in the embodiment illustrated in FIG. 3, the add-on application communicates with the operating system application of the mobile device 304 to control and receive data from at least the image capture device 306, display device 308, and the user input device 310. In some embodiments, the add on application is an add on browser application that cooperates with graphical displays generated by and transmitted to the mobile device 304 from the control circuit 302 or other server for display at the mobile device 304. In some embodiments, the application 312 is integral with other applications of the mobile device such as the operating system. For example, in the embodiment illustrated in FIG. 3, the integral application controls and receives data from at least the image capture device 306, the display device 308, and the user input device 310. In some embodiments, where the application is integral with the operating system, the application may be considered a functional portion or module of the operating system, such as a browser or other dedicated functional module.

In some embodiments, when a store associate launches the mobile application 312 executing on the mobile device 304, the mobile application 312 may communicate with the control circuit 302 information associated with the mobile device 304 (e.g., serial number, location, etc.), which the control circuit 302 may use to identify the mobile device 304 and/or the user of the mobile device 304. In some approaches, when the store associate launches the mobile application 312 executing on the mobile device 304, the associate may be presented with a number of modules for selection (e.g., an inventory module, an order fulfillment module, an audit module, etc.) and may select the appropriate module based on the desired task by tapping on the appropriate icon displayed by the display device 308.

When the store associate orients the mobile device 304 toward a shelving unit storing inventory items having fiducial markers affixed thereto, the mobile application 312 is configured to cause the presentation of a real-world view of the shelving unit on the display device 308 via the image capture device 306. Using the image capture device 306, the application 312 captures information related to the fiducial markers and transmits this information to the control circuit 302 for processing. In some approaches, the application 312 may transmit to the control circuit 302 one or more selections of information filters the associate wishes to apply. As noted above, instead, or in addition, the control circuit 302 may select the one or more information filters. Once the control circuit 302 applies the information filters, the application 312 is configured to present an augmented view of the shelving unit on the display device 308. Specifically, the application 312 is configured to display an indication over each inventory item (and/or associated fiducial markers) having the specified attribute(s) from the applied information filter(s) such that the store associate is alerted to inventory items that require the associate's attention. The indications may include, for example, any symbol, shape, icon, or text, and may have any suitable color, as described herein. The application 312 may also display in the augmented view one or more action items as determined by the control circuit 302.

After the store associate has attended to the inventory items having the specified attributes and/or action items (e.g., by picking, removing, or otherwise attending to the items), the store associate indicates, using the user input device 310 in cooperation with the mobile application 312, that the inventory items have been attended to. For example, the store associate may tap on the indication displayed over the inventory items in the augmented view displayed by the display device 308 to denote that the items have attended to. The application may be configured to cause the tapped indications to change in form, shape and/or color, or to cause the tapped indications to disappear altogether. In some approaches, the application 312 may then transmit to the control circuit 302 one or more signals that the relevant inventory items have been attended to.

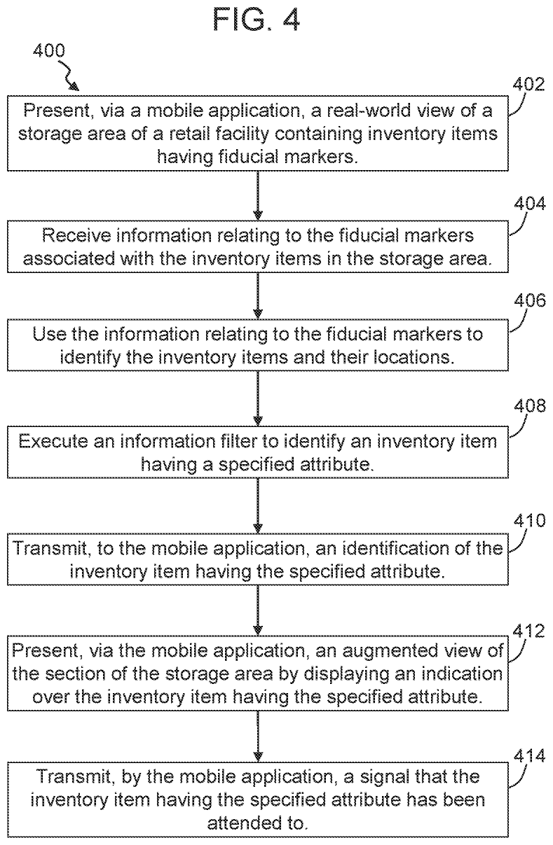

FIG. 4 depicts a simplified flow diagram of an exemplary process 400 of managing inventory using augmented reality, in accordance with some embodiments. The process 400 may be implemented using various embodiments of the inventory management system 100 described herein and other inventory management systems.

In step 402, an application executing on a mobile device (i.e., a mobile application) operated by a user presents a real-world view of a section of a storage area of a retail facility containing inventory items. The storage area may be located in any suitable area of a retail facility. For example, in some approaches, the storage area may be located in a non-public storage area (i.e., in a backroom) of the retail facility. In other approaches, the storage area may be located in a public are (i.e., on the sales floor) of the retail facility.

The section of the storage area may comprise, for example, one or more shelving units containing inventory items in a retail facility or otherwise a more generic product storage unit containing the inventory items. Each inventory item has one or more fiducial markers associated therewith to uniquely identify each inventory item. The fiducial markers may comprise the fiducial markers described herein with reference to FIGS. 1 to 3.

In some approaches, the real-world view is captured by an image capture device associated with the mobile device and the section of the storage area presented in the real-world view corresponds to a field of view of the image capture device. The mobile device may comprise the mobile device described herein with reference to FIGS. 1 to 3 and 5. In some approaches, sections of the shelving unit may also be tagged with one or more fiducial markers to tie inventory items to specific locations.

In step 404, information relating to the fiducial markers associated with the inventory items in the section of the storage area is received. In some approaches, the image capture device associated with mobile device captures images and/or information associated with the fiducial markers and the application associated with the mobile device transmits the images and/or information to a control circuit. In some approaches, images and/or information associated with the fiducial markers may be captured by one or more image capture devices disposed about the storage area and transmitted to the control circuit and/or the mobile application.

In step 406, the information relating to the fiducial markers is used by the control circuit to identify the inventory items and the locations of the inventory items in the section of the storage area. The control circuit may identify the inventory items by, for example, querying databases containing data relating to the inventory items and fiducial markers. The system may determine locations of the inventory items on the shelving unit by, for example, using one or more of the shelf tags contain fiducial markers.

In step 408, the control circuit executes an information filter to identify one or more inventory items having a specified attribute in the section of the storage area. Non-limiting examples of information filters may relate to inventory picks, order picks, uncounted items, recalled items, featured items, clearance items, final markdown items, priority items, deleted items, purged items, expiration dates, harvest dates, and freshness dates. In some approaches, information filters may be applied one at a time. In other approaches, multiple information filters may be applied simultaneously. In some approaches, the store associate may select one or more information filters by making selections using the mobile device. In other approaches, the control circuit may select one or more information filters to apply. In both scenarios, the control circuit applies the information filter(s) and identifies inventory items having the specified attribute(s).

In step 410, the control circuit transmits to the mobile application the identifications of the one or more inventory items having the specified attribute, the identifications being determined in step 408 by the control circuit. As noted above, the identifications may relate to one or multiple information filters.

In step 412, the mobile application presents an augmented view of the section of the storage area by displaying an indication over each inventory item having the specified attribute. As discussed herein with reference to FIGS. 2B and 2C, the indications displayed in the augmented view may comprise any symbol, shape, icon, or text, may have any suitable color, and may be based on the type of information filter(s) used, ease of viewing, user preference, etc. In some approaches, indications associated with only one information filter are displayed. In other approaches, various indications associated with multiple information filters may be displayed simultaneously. In some approaches, the control circuit may also determine one or more action items for the inventory items and may transmit these action items to the mobile application. The mobile application then presents in the augmented view an action indicator over inventory items in need of the action items. An action indicator may comprise, for example, a text label indicating a specific action needed.

In step 414, the mobile application transmits to the control circuit one or more signals that the inventory items having the specified attribute have been attended to by the user. For example, the user (i.e., a store associate) proceeds to remove from the shelving unit the inventory items having the specified attribute and signals using the mobile application that the inventory items have been attended to (i.e., removed from the shelving unit) by the user. In some approaches, the store associate may utilize a user display of the mobile device to tap on the indication displayed over the inventory items having the selected attribute to denote that the items have been removed or otherwise attended to, at which point the indications may change in form, shape and/or color, or may disappear altogether to denote a completed action.

In some approaches, upon receiving from the mobile application the one or more signals that the inventory items having the specified attribute have been removed or otherwise attended to by the user, the control circuit may update an inventory management module as to the status and/or location of the inventory items. In some approaches, the control circuit may also determine that an inventory item is no longer present in the section of the storage area after a specified duration of time and may update the inventory management module and/or one or more databases accordingly.

The discussion of FIG. 5 provides additional detail regarding example mobile devices and applications configured to be executed on mobile devices. FIG. 5 is a block diagram of a mobile device 500, according to some embodiments. The mobile device 500 may be used for implementing any of the components, systems, functionality, apparatuses, processes, or devices of the system of FIGS. 1 to 4, and/or other above or below mentioned systems or devices, or parts of such functionality, systems, apparatuses, processes, or devices. The systems, devices, processes, methods, techniques, functionality, services, servers, sources and the like described herein may be utilized, implemented and/or run on many different types of devices and/or systems.

By way of example, the mobile device 500 may comprise a control circuit or processor 512, memory 514, and one or more communication links, paths, buses or the like 518. Some embodiments may include one or more user interfaces 516, and/or one or more internal and/or external power sources or supplies 540. The control circuit 512 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor 512 can be part of control circuitry and/or a control system 510, which may be implemented through one or more processors with access to one or more memory 514 that can store commands, instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 500 may be used to implement one or more of the above or below, or parts of, components, circuits, systems, processes and the like.

In one embodiment, the memory 514 stores data and executable program code, such as an operating system 536 and an application 538. The application 538 is configured to be executed by the mobile device 500 (e.g., by the processor 512). The application 538 can be a dedicated application (e.g., an application dedicated to inventory management tasks) and/or a general purpose application (e.g., a web browser, a retail application etc.). Additionally, though only a single instance of the application 538 is depicted in FIG. 5, such is not required and the single instance of the application 538 is shown in an effort not to obfuscate the figures. Accordingly, the application 538 is representative of all types of applications resident on the mobile device (e.g., software preinstalled by the manufacturer of the mobile device, software installed by an end user, etc.). In one embodiment, the application 538 operates in concert with the operating system 536 when executed by the processor 512 to cause actions to be performed by the mobile device 500. For example, with respect to the disclosure contained herein, execution of the application 538 by the processor 512 causes the mobile device to perform actions consistent with the inventory management and augmented reality tasks and tools described herein.

The user interface 516 can allow a user to interact with the system 500 and receive information through the system. In some instances, the user interface 516 includes a display device 522 and/or one or more user input device 524, such as buttons, touch screen, track ball, keyboard, mouse, etc., which can be part of or wired or wirelessly coupled with the mobile device 500. Typically, the mobile device 500 further includes one or more communication interfaces, ports, transceivers 520 and the like allowing the mobile device 500 to communicate over a communication bus, a distributed computer and/or communication network (e.g., a local area network (LAN), wide area network (WAN) such as the Internet, etc.), communication link 518, other networks or communication channels with other devices and/or other such communications or combination of two or more of such communication methods. Further the transceiver 520 can be configured for wired, wireless, optical, fiber optical cable, satellite, or other such communication configurations or combinations of two or more of such communications. Some embodiments include one or more input/output (I/O) ports 534 that allow one or more devices to couple with the mobile device 500. The I/O ports can be substantially any relevant port or combinations of ports, such as but not limited to USB, Ethernet, or other such ports. The I/O interface 534 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the mobile device 500 may include one or more sensors 526 to provide information to the system and/or sensor information that is communicated to another component, such as the central control system, a delivery vehicle, etc. The sensors 526 can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The mobile device 500 comprises an example of a control and/or processor-based system with the control circuit 512. Again, the control circuit 512 can be implemented through one or more processors, controllers, central processing units, logic, software and the like. Further, in some implementations the control circuit 512 may provide multiprocessor functionality.

The memory 514, which can be accessed by the control circuit 512, typically includes one or more processor-readable and/or computer-readable media accessed by at least the control circuit 512, and can include volatile and/or nonvolatile media, such as RAM, ROM, EEPROM, flash memory and/or other memory technology. Further, the memory 514 is shown as internal to the control system 510; however, the memory 514 can be internal, external or a combination of internal and external memory. Similarly, some or all of the memory 514 can be internal, external or a combination of internal and external memory of the control circuit 512. The external memory can be substantially any relevant memory such as, but not limited to, solid-state storage devices (SSDs) or drives, hard disk drives (HDDs), one or more of universal serial bus (USB) stick or drive, flash memory secure digital (SD) card, other memory cards, and other such memory or combinations of two or more of such memory, and some or all of the memory may be distributed at multiple locations over a computer network. The memory 514 can store code, software, executables, scripts, data, content, lists, programming, programs, log or history data, user information, customer information, product information, and the like. While FIG. 5 illustrates the various components being coupled together via a bus, it is understood that the various components may actually be coupled to the control circuit and/or one or more other components directly.

Further, it is noted that while FIG. 5 illustrates a generic architecture of the mobile device 500 in some embodiments, this similar architecture can apply to at least the control circuit 302, the inventory management module 316, the storage image capture device(s) 318, the image processing module 320, the online retail system 322, the retail control circuit 323, and the remote electronic device 324. For example, the control circuit 302 and/or the retail control circuit 323 could equate to the control circuit or processor 512 of FIG. 5, and it is understood that the control circuit 302 and/or the retail control circuit 323 would likewise be coupled to or have access to one or more of memories, power, user interfaces, I/Os, transceivers, sensors, modules, databases, etc. Similarly, in some embodiments, the mobile device 304, the inventory management module 316, the storage image capture device(s) 318, the remote electronic device 323, and/or the image processing module 320 could be embodied to include at least one control circuit, memories, power, user interfaces, I/Os, transceivers, sensors, databases, etc.

In some embodiments, an inventory management system comprises: a retail facility having a storage area containing inventory items stored therein, each inventory item having a fiducial marker associated therewith to uniquely identify each inventory item; a control circuit, wherein the control circuit is configured to: receive information relating to fiducial markers associated with the inventory items located in the storage area; use the information relating to the fiducial markers to identify the inventory items and determine locations of the inventory items; execute an information filter to identify an inventory item having a specified attribute; and transmit, to an application executing on a mobile device operated by a user, an identification of the inventory item having the specified attribute; and the application, wherein when executed by the mobile device, is configured to: present, on a user interface of the mobile device, a real-world view of the storage area containing the inventory items; transmit, to the control circuit, the information relating to the fiducial markers associated with the inventory items; obtain, from the control circuit, the identification of the inventory item having the specified attribute; present an augmented view of the storage area by displaying an indication over the inventory item having the specified attribute; and receive from the user, and transmit to the control circuit, a signal that the inventory item having the specified attribute has been attended to by the user.

In some embodiments, a method of managing inventory comprises: causing presentation, by an application executing on a mobile device operated by a user, of a real-world view of a storage area of a retail facility containing inventory items, each having a fiducial marker associated therewith to uniquely identify each inventory item; receiving, at a control circuit, information relating to fiducial markers associated with the inventory items in the storage area; by the control circuit, using the information relating to the fiducial markers to identify the inventory items and locations of the inventory items; executing, by the control circuit, an information filter to identify an inventory item having a specified attribute; transmitting, to the application executing on the mobile device, by the control circuit, an identification of the inventory item having the specified attribute; presenting, by the application executing on the mobile device, an augmented view of the storage area by displaying an indication over the inventory item having the specified attribute; and transmitting, to the control circuit, by the application executing on the mobile device, a signal that the inventory item having the specified attribute has been attended to by the user.

In some embodiments, a system for inventory management comprises: a control circuit, wherein the control circuit is configured to: receive, from an application configured to be executed on a mobile device operated by a user, information relating to fiducial markers associated with inventory items located in a storage area of a retail facility, where each inventory item has a fiducial marker associated therewith to uniquely identify each inventory item; use the information relating to the fiducial markers to identify the inventory items and determine locations of the inventory items; execute an information filter to identify an inventory item having a specified attribute; and transmit, to the application executing on the mobile device, an identification of the inventory item having the specified attribute; and the application, wherein when executed by the mobile device, is configured to: present, on a user interface of the mobile device, a real-world view of the storage area containing the inventory items; transmit, to the control circuit, the information relating to the fiducial markers associated with the inventory items; obtain, from the control circuit, the identification of the inventory items having a specified attribute; present an augmented view of the section of the storage area by displaying an indication over the inventory item having the specified attribute; and receive from the user, and transmit to the control circuit, a signal that the inventory item having the specified attribute has been attended to by the user.

In some embodiments, an inventory management system comprises: an image capture device, wherein the image capture device is configured to capture images of inventory items in a storage area, each inventory item having a fiducial marker associated therewith to uniquely identify each inventory item; and a control circuit, wherein the control circuit is configured to: receive, from the image capture device, an image of the inventory items in the storage area; identify the inventory items and determine locations of the inventory items based in the fiducial marker associated with each inventory item; execute an information filter to identify an inventory item having a specified attribute; transmit, to an application executing on a mobile device operable by a user, an identification of the inventory item having the specified attribute; cause the application executing on the mobile device to present an augmented view of the storage area by displaying an indication over the inventory item having the specified attribute; and receive from the application executing on the mobile device a signal that the inventory item having the specified attribute has been attended to by the user.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. An inventory management system comprising:
a retail facility having a storage area containing inventory items stored therein, each inventory item having a fiducial marker associated therewith to uniquely identify each inventory item;
a control circuit, wherein the control circuit is configured to:
receive information relating to fiducial markers associated with the inventory items located in the storage area;
use the information relating to the fiducial markers to identify the inventory items and determine locations of the inventory items;
execute an information filter to identify an inventory item having a specified attribute; and
transmit, to an application executing on a mobile device operated by a user, an identification of the inventory item having the specified attribute; and
the application, wherein when executed by the mobile device, is configured to:
present, on a user interface of the mobile device, a real-world view of the storage area containing the inventory items;
transmit, to the control circuit, the information relating to the fiducial markers associated with the inventory items;
obtain, from the control circuit, the identification of the inventory item having the specified attribute;
present an augmented view of the storage area by displaying an indication over the inventory item having the specified attribute; and
receive from the user, and transmit to the control circuit, a signal that the inventory item having the specified attribute has been attended to by the user.

2. The system of claim 1, further comprising an inventory management module, wherein the control circuit is configured to update the inventory management module upon receiving, from the application executing on the mobile device, the signal that the inventory item having the specified attribute has been attended to by the user.

3. The system of claim 1, wherein the control circuit is further configured to determine an action item for one or more of the inventory items, and the application executing on the mobile device is configured to display an action indicator over the one or of the more inventory items having the action item in the augmented view.

4. The system of claim 3, wherein the application executing on the mobile device is further configured to receive from the user a second signal that the action item for the inventory item has been completed, and the application transmits the second signal to the control circuit.

5. The system of claim 1, wherein the control circuit is configured to automatically select and apply the information filter from a plurality of information filters.

6. The system of claim 1, wherein the application executing on the mobile device receives from the user, and transmits to the control circuit, a selection of the information filter from a plurality of selectable information filters.

7. The system of claim 1, wherein the information filter relates to at least one of inventory picks, order picks, uncounted items, recalled items, featured items, clearance items, final markdown items, priority items, deleted items, purged items, expiration dates, harvest dates, and freshness dates.

8. The system of claim 1, further comprising an inventory management module, wherein the control circuit is further configured to determine that an inventory item is no longer present in the section of the storage area after a specified duration of time and the control circuit is configured to update the inventory management module.

9. The system of claim 1, wherein the inventory items comprise product cases and each product case contains individual products for sale.

10. The system of claim 9, wherein each inventory item comprises an individual product for sale.

11. A method of managing inventory, the method comprising:
causing presentation, by an application executing on a mobile device operated by a user, of a real-world view of a storage area of a retail facility containing inventory items, each having a fiducial marker associated therewith to uniquely identify each inventory item;
receiving, at a control circuit, information relating to fiducial markers associated with the inventory items in the storage area;
by the control circuit, using the information relating to the fiducial markers to identify the inventory items and locations of the inventory items;
executing, by the control circuit, an information filter to identify an inventory item having a specified attribute;
transmitting, to the application executing on the mobile device, by the control circuit, an identification of the inventory item having the specified attribute;
presenting, by the application executing on the mobile device, an augmented view of the storage area by displaying an indication over the inventory item having the specified attribute; and
transmitting, to the control circuit, by the application executing on the mobile device, a signal that the inventory item having the specified attribute has been attended to by the user.

12. The method of claim 11, further comprising updating, by the control circuit, an inventory management module upon receiving, from the application executing on the mobile device, the signal that the inventory item having the specified attribute has been attended to by the user.

13. The method of claim 11, further comprising determining, by the control circuit, an action item for one or more of the inventory items, and displaying, by the application executing on the mobile device, an action indicator over the one or more of the inventory items having the action item in the augmented view.

14. The method of claim 13, further comprising, receiving, by the application executing, from the user a second signal that the action item for the inventory item has been completed, and transmitting the second signal to the control circuit.

15. The method of claim 11, wherein the control circuit is configured to automatically select and apply the information filter from a plurality of information filters.

16. The method of claim 11, wherein the application executing on the mobile device receives from the user, and transmits to the control circuit, a selection of the information filter from a plurality of selectable information filters.

17. The method of claim 11, wherein the information filter relates to at least one of inventory picks, order picks, uncounted items, recalled items, featured items, clearance items, final markdown items, priority items, deleted items, purged items, expiration dates, harvest dates, and freshness dates.

18. The method of claim 11, further comprising, by the control circuit, determining that an inventory item is no longer present in the section of the storage area after a specified duration of time and updating an inventory management module.

19. The method of claim 11, wherein the inventory items comprise product cases and each product case contains individual products for sale.

20. The method of claim 19, wherein each inventory item comprises an individual product for sale.

21. An inventory management system comprising:
a control circuit, wherein the control circuit is configured to:
receive, from an application configured to be executed on a mobile device operated by a user, information relating to fiducial markers associated with inventory items located in a storage area of a retail facility, where each inventory item has a fiducial marker associated therewith to uniquely identify each inventory item;
use the information relating to the fiducial markers to identify the inventory items and determine locations of the inventory items;
execute an information filter to identify an inventory item having a specified attribute; and
transmit, to the application executing on the mobile device, an identification of the inventory item having the specified attribute; and
the application, wherein when executed by the mobile device, is configured to:
present, on a user interface of the mobile device, a real-world view of the storage area containing the inventory items;
transmit, to the control circuit, the information relating to the fiducial markers associated with the inventory items;
obtain, from the control circuit, the identification of the inventory items having a specified attribute;
present an augmented view of the section of the storage area by displaying an indication over the inventory item having the specified attribute; and
receive from the user, and transmit to the control circuit, a signal that the inventory item having the specified attribute has been attended to by the user.

22. An inventory management system comprising:
an image capture device, wherein the image capture device is configured to capture images of inventory items in a storage area, each inventory item having a fiducial marker associated therewith to uniquely identify each inventory item; and
a control circuit, wherein the control circuit is configured to:
receive, from the image capture device, an image of the inventory items in the storage area;
identify the inventory items and determine locations of the inventory items based in the fiducial marker associated with each inventory item;
execute an information filter to identify an inventory item having a specified attribute;
transmit, to an application executing on a mobile device operable by a user, an identification of the inventory item having the specified attribute;
cause the application executing on the mobile device to present an augmented view of the storage area by displaying an indication over the inventory item having the specified attribute; and
receive from the application executing on the mobile device a signal that the inventory item having the specified attribute has been attended to by the user.
